(19) United States
(12) Patent Application Publication
(10) Pub. No.: US 2014/0335290 A1
(43) Pub. Date: Nov. 13, 2014

(54) CONDUCTIVE SEALANT, DISPLAY PANEL AND MANUFACTURING METHOD THEREOF, AND DISPLAY DEVICE

(71) Applicant: BOE TECHNOLOGY GROUP CO., LTD., Beijing (CN)

(72) Inventors: Yu Zhang, Beijing (CN); Jaegeon You, Beijing (CN)

(73) Assignee: BOE TECHNOLOGY GROUP CO., LTD., Beijing (CN)

(21) Appl. No.: 14/346,092

(22) PCT Filed: Jul. 22, 2013
(86) PCT No.: PCT/CN2013/079822

§ 371 Date: Mar. 20, 2014

(30) Foreign Application Priority Data
May 2, 2013 (CN) 201310158396.8

(51) Int. Cl. G02F 1/1339

(52) U.S. Cl. CPC G02F 1/1339; G02F 2001/13398
USPC 428/1.55; 156/325; 156/332; 252/511

(57) ABSTRACT

A conductive sealant comprises a sealant material and conductive particles, wherein the conductive particles are of a composite material obtained by adding graphene or carbon nanotubes into a resin. The conductive sealant avoids the problem of bad electrical conduction of the display panel caused by the aggregation of graphene. A display panel and a manufacturing method thereof and a display device are further provided.

### TECHNICAL FIELD

Embodiments of the present invention relate to a conductive sealant, a display panel and a manufacturing method thereof, and a display device.

### BACKGROUND

With the continuous popularity of liquid crystal display (LCD), the requirements of users upon the functions of liquid crystal displays are becoming higher. During the production process of an LCD panel, a conductive sealant is adopted mainly for bonding a color filter substrate and an array substrate to form a liquid crystal cell and for realizing conduction between the array substrate and the color filter substrate.

As illustrated in FIG. 1, the conductive sealant adopted by a current LCD panel comprises a sealant 10 and conductive particles 11 of organic resin wrapped with graphene. The sealant 10 can realize bonding between the color filter substrate and the array substrate, and the conductive particles 11 of organic resin wrapped with graphene can realize conduction between the array substrate and the color filter substrate.

However, since graphene has great specific surface area, it is prone to be subject to irreversible aggregation. The aggregation of graphene may lead to conduction defect in the LCD panel and thus disadvantageously affect the display effect of the LCD panel.

### SUMMARY

Embodiments of the present invention provide a conductive sealant, a display panel and a manufacturing method thereof, and a display device, which can solve the problem of bad electrical conduction of a display panel caused by aggregation of graphene and can improve the display effect of the display panel.

One aspect of the present invention provides a conductive sealant, comprising a sealant material and conductive particles, wherein the conductive particles are of a composite material obtained by adding graphene or carbon nanotubes into a resin.

Another aspect of the present invention provides a display panel, comprising a first substrate and a second substrate that are disposed opposite to each other, a conductive sealant with any of the aforementioned features being disposed between the first substrate and the second substrate opposite to each other.

For example, the composite material obtained by adding graphene or carbon nanotubes into a resin is a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).

For example, a grain size of the conductive particle is within a range of 100 nm to 10000 nm.

For example, the grain size of the conductive particle is 1.2 to 1.5 times greater than a cell gap of the display panel, and the cell gap of the display panel is a distance between the first substrate and the second substrate.

For example, the conductive particles are uniformly distributed in the conductive sealant.

A further aspect of the present invention provides a manufacturing method of a display panel, comprising: forming an array substrate; forming an opposed substrate; disposing a conductive sealant on the array substrate and/or the opposed substrate; the array substrate and the opposed substrate being disposed opposite to each other; the conductive sealant comprising a sealant material and conductive particles, and the conductive particles are of a composite material obtained by adding graphene or carbon nanotubes into a resin.

For example, a process of manufacturing the conductive sealant comprises: adding the conductive particles into the sealant material and stirring, and performing vacuum defoaming so as to manufacture the conductive sealant.

For example, the composite material obtained by adding graphene or carbon nanotubes into a resin is a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).

A further aspect of the present invention provides a display device, comprising any one of the aforementioned display panels.

### BRIEF DESCRIPTION OF THE DRAWINGS

In order to clearly illustrate the technical solution of the embodiments of the invention, the illustrative drawings used for describing the embodiments will be briefly described in the following. It is obvious that the described drawings are only related to some embodiments of the invention and thus are not limitative of the invention.

FIG. 1 is a structural schematic view of the LCD panel of the prior art;

FIG. 2 is a structural schematic view of the display panel provided by the present invention; and

FIG. 3 is a flow chart of the manufacturing method of the display panel provided by the present invention.

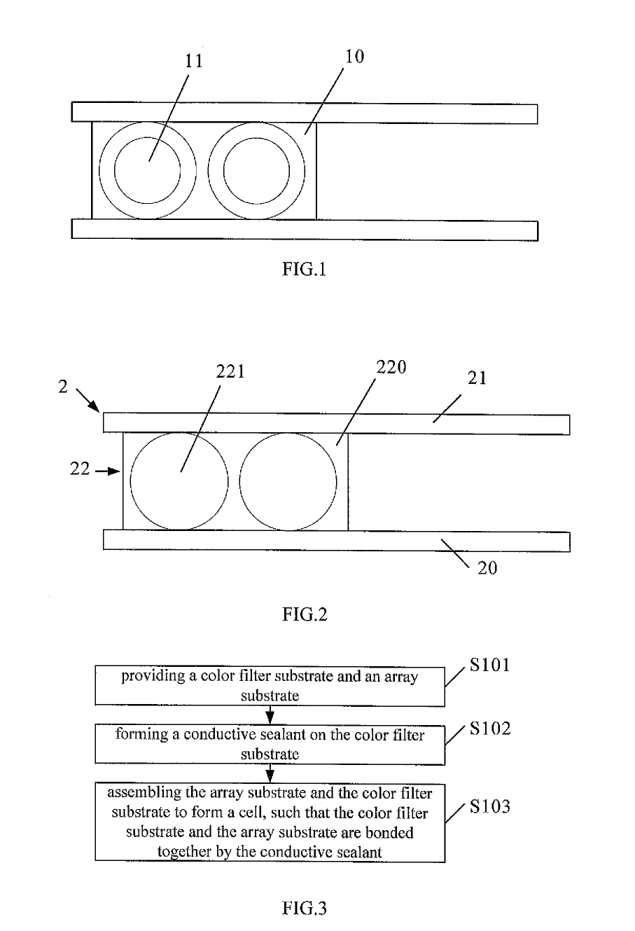

### DETAILED DESCRIPTION

In order to make the object, technical solution and advantages of the present invention clearer, the technical solutions in the embodiments of the present invention will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

The embodiments of the present invention provide a conductive sealant comprising a sealant material and conductive particles, and the conductive particles are of a composite material obtained by adding graphene or carbon nanotubes into a resin.

The composite material obtained by adding graphene or carbon nanotubes into a resin is, for example, a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).

The conductive sealant provided by an embodiment of the present invention comprises a sealant material and conductive particles, and the conductive particles belong to a composite material obtained by adding graphene or carbon nanotubes into a resin. On one hand, introduction of the resin reduces the specific surface area of graphene so as to avoid aggregation of graphene; on the other hand, introduction of the resin reduces the Van der Waals force among carbon nanotubes so as to provide good conductibility and supporting effect. Therefore, where the conductive sealant is applied to a display panel, the problem of bad electrical conduction of the display panel caused by the aggregation of graphene can be solved and the display effect of the display panel can be improved.

An embodiment of the present invention provides a display panel, comprising a first substrate and a second substrate that are disposed opposite to each other, and any one kind of the above-mentioned conductive sealants is disposed between the first substrate and the second substrate opposite to each other.

As illustrated in FIG. 2, a display panel 2 of the present invention comprises: an array substrate 20 and a color filter substrate 21 that are disposed opposite to each other, and a conductive sealant 22 disposed between the array substrate 20 and the color filter substrate 21. Herein, the array substrate 20 and the color filter substrate 21 are illustrative examples of the first substrate and the second substrate respectively.

The conductive sealant 22 comprises a sealant material 220 and conductive particles 221. The sealant material 220 is used for bonding the color filter substrate 20 and the array substrate 21 together so as to form, e.g. a liquid crystal cell accommodating liquid crystal materials therein, and the conductive particles 221 can realize electrical conduction between the array substrate 220 and the color filter substrate 221. The conductive particles 221 in the embodiment of the present invention are of a composite material obtained by adding graphene or carbon nanotubes into a resin.

Furthermore, the conductive sealant 22 may be disposed on the array substrate 20 only, on the color filter substrate 21 only, or on both the array substrate 20 and the color filter substrate 21, which are not limits to the embodiments of the present invention.

For example, the composite material obtained by adding graphene to a resin is, for example, a composite material of graphene and polystyrene, or a composite material of graphene and polymethylmethacrylate (PMMA), and the composite material obtained by adding carbon nanotubes to a resin is a composite material of carbon nanotubes and polystyrene, or a composite material of carbon nanotubes and polymethylmethacrylate (PMMA).

What needs to be explained is that the materials for the conductive particles disclosed in the embodiments of the present invention may adopt different conductive matrix materials according to different matrix materials. For example, if the matrix material is polystyrene, a composite material obtained by adding graphene or carbon nanotubes to polystyrene may be manufactured by taking graphene or carbon nanotubes as the conductive matrix material. If the matrix material is polymethylmethacrylate (PMMA), a composite material obtained by adding graphene or carbon nanotubes to polymethylmethacrylate (PMMA) may be manufactured by taking graphene or carbon nanotubes as the conductive matrix material. These are just preferable solutions. Other types of resin materials that can prevent graphene from aggregation or overcome the Van der Waals force of carbon nanotubes may also be adopted, which is not a limit to the embodiment of the present invention.

For example, the grain size of the conductive particle is within a range of 100 nm to 10000 nm. The particular grain size may be determined according to the practical need and is not a limit to the embodiment of the present invention.

What needs to be explained is that the grain size of the conductive particle is related to the distance between the array substrate and the color filter substrate after a cell-assembling process (i.e., the cell gap). Since the conductive particles manufactured in the embodiments of the present invention have not only the conducting effect but also the effect of supporting the cell gap, the grain size of the conductive particle is preferably greater than a distance between the any substrate (i.e., the first substrate) and the color filter substrate (i.e., the second substrate), and generally 1.2 to 1.5 times greater than the cell gap.

Furthermore, the conductive particles are uniformly distributed in the conductive sealant so as to provide the display panel with good electrical conducting effect and improved display effect.

To sum up, with regard to the conductive sealant of the display panel provided in an embodiment of the present invention, firstly, the conductive particles have simple structures, and what is needed is to add the conductive particles into the sealant material such that the resulted conductive sealant produces both the supporting effect and the conducting effect, without including additional spacers such as glass fibers; secondly, since the conductive particles are bonded by copolymerization, the conductive particles have great compressive resistance and strong resilience and so cracking phenomenon will not occur; thirdly, due to the introduction of resin, the specific surface area of the graphene, the inherent Van der Waals force among the carbon nanotubes, and the aggregation phenomenon of the graphene are reduced such that the conductive particles are uniformly dispersed in the sealant material; fourthly, during the process of introducing the graphene or carbon nanotubes into the conductive sealant, the heat resistance of the conductive sealant has been greatly improved, and at the same time, the conductive particles are provided with conductibility since the graphene or carbon nanotubes has good electrical conductibility.

An embodiment of the present invention provides a display panel, comprising an array substrate and an opposed substrate (e.g., color filter substrate) opposite to each other, and a conductive sealant disposed between the array substrate and the opposed substrate. The conductive sealant comprises a sealant material and productive particles, and the conductive particles are of a composite material obtained by adding graphene or carbon nanotubes into a resin. On one hand, the introduction of resin reduces the specific surface area of graphene so as to avoid aggregation of the graphene; on the other hand, introduction of resin reduces the Van der Waals force among carbon nanotubes so as to provide good conductibility and supporting effect. Therefore, the problem of bad electrical conduction of the display panel caused by the aggregation of graphene can be solved and the display effect of the display panel can be improved. The opposed substrate may not have any color filters and is not a color filter substrate. For example, when the array substrate is a color filter on array (COA) substrate, there is no need to dispose color filters on the opposed substrate again.

An embodiment of the present invention provides a display device, which comprises any one of the aforementioned display panels. The display device may be a liquid crystal display, an e-paper device, an OLED (Organic Light-Emitting Diode) panel, a mobile phone, a flat panel computer, a television, a display, a notebook computer, a digital photoframe, a navigator and any other products or members having display function.

An embodiment of the present invention provides a manufacturing method of a display panel, comprising the following steps: forming an array substrate; forming an opposed substrate; disposing a conductive sealant on the array substrate and/or the opposed substrate; the array substrate and the opposed substrate being disposed opposite to each other; the conductive sealant comprising a sealant material and conductive particles, and the conductive particles are of a composite material obtained by adding graphene or carbon nanotubes into a resin. One of the examples of opposed substrate is a color filter substrate.

As illustrated in FIG. 3, one example of the manufacturing method of the display provided in the embodiment of the present invention comprises:

S101. providing a color filter substrate and an array substrate;

S102. forming a conductive sealant on the color filter substrate.

The conductive sealant comprises a sealant material and conductive particles. The sealant material is used for bonding the color filter substrate and the array substrate together, and the conductive particles realize electrical conduction between the array substrate and the color filter substrate. The conductive particles in the present embodiment are of a composite material obtained by adding graphene or carbon nanotubes into a resin.

Preferably, the composite material obtained by adding graphene to a resin is, for example, a composite material of graphene and polystyrene, or a composite material of graphene and Polymethylmethacrylate (PMMA), and the composite material obtained by adding carbon nanotubes to a resin is a composite material of carbon nanotubes and polystyrene, or a composite material of carbon nanotubes and polymethylmethacrylate (PMMA).

What needs to be explained is that the materials for the conductive particles disclosed in the embodiments of the present invention may adopt different conductive matrix materials according to different matrix materials. For example, if the matrix material is polystyrene, a composite material obtained by adding graphene or carbon nanotubes to polystyrene may be manufactured by taking graphene or carbon nanotubes as the conductive matrix material. If the matrix material is polymethylmethacrylate (PMMA), a composite material obtained by adding graphene or carbon nanotubes to polymethylmethacrylate (PMMA) may be manufactured by taking graphene or carbon nanotubes as the conductive matrix material. These are just preferable solutions. Other types of resin materials that can prevent graphene from aggregation or overcome the Van der Waals force of the carbon nanotubes may also be adopted, which is not a limit to the embodiment of the present invention.

The examples of the manufacturing method of the conductive sealant comprise: adding the conductive particles into the sealant material and stirring, and performing vacuum defoaming so as to manufacture the conductive sealant.

The composite material obtained by adding graphene or carbon nanotubes into a resin is, for example, a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).

The conductive sealant in the embodiment of the present invention not only has good bonding effect but also good electrical conductive performance because of the existence of graphene or carbon nanotubes in the conductive particles. The polystyrene or polymethylmethacrylate (PMMA) has good elasticity and ductility, which provides good support function. In addition, the composite material of the graphene and polystyrene greatly improves the heat resistance performance of the polystyrene, which therefore may be applied more widely as a supporting material.

Furthermore, the method of preparing the composite material of graphene and polystyrene of 5 to 25 grams is illustratively introduced herein. The method comprises the following steps.

S201. dissolving 100 mg to 300 mg of oxidized graphene in 50 ml to 200 ml of deionized water, adding 0.01 g to 5 g of sodium dodecyl sulfate (SDS) and 5 g to 30 g of styrene, and performing ultrasonic treatment for 10 to 20 minutes.

S202. adding 0.05 g to 0.3 g of sodium persulfate to the solution obtained in the aforementioned step, and stirring for 15 hours in a nitrogen gas protection environment under 80 □.

S203. adding 10 ml to 30 ml of hydrazine hydrate to the solution obtained in the aforementioned step, and electromagnetic stirring for 2 hours under 100 □.

S204. cooling the solution obtained in the aforementioned step to the room temperature, suction-filtering and washing with deionized water and acetone, and drying under a vacuum environment under 60 □, so as to manufacture the composite material of graphene and polystyrene.

Furthermore, the method of preparing the composite material of graphene and polymethylmethacrylate (PMMA) is illustratively introduced herein. The method comprises the following steps.

S301. dissolving 100 mg to 200 mg of oxidized graphene in 100 ml to 200 ml of deionized water, and performing ultrasonic stripping treatment to obtain an aqueous dispersion solution of oxidized graphene.

S302. adding 5 g to 20 g of methyl methacrylate (MMA) and 0.5 g to 2 g of polyvinylpyrrolidone (PVP) to the aqueous dispersion solution of oxidized graphene, and performing ultrasonic treatment for 15 minutes.

S303. adding 0.1 g to 0.3 g of azobisisobutyronitrile (AIBN) dissolved in 200 ml to 300 ml of methyl alcohol to the solution obtained in the aforementioned step, performing ultrasonic treatment for 10 minutes in a nitrogen gas protection environment, and stirring for 10 hours under 80 □.

S304. adding 5 ml to 10 ml of 80% hydrazine hydrate to the solution obtained in the aforementioned step, and stirring for 4 hours under 100 □.

S305. cooling the solution obtained in the aforementioned step to the room temperature, suction-filtering and washing with deionized water and ethanol, so as to manufacture the composite material of graphene and polymethylmethacrylate (PMMA).

Furthermore, the method of preparing the composite material of carbon nanotubes and polymethylmethacrylate (PMMA) is illustratively introduced herein. The method comprises the following steps.

S401, mixing 10 g to 20 g of methyl methacrylate (MMA) with 0.2 w % to 0.5 w % of azobisisobutyronitrile (AIBN) in deionized water under 50 □.

S402. heating the solution obtained in the aforementioned step in a water bath under 85 □ for 15 minutes, and stirring every three minutes during the process.

S403. adding 0.2 g to 2 g of carbon nanotubes to the solution obtained in the aforementioned step, reacting for 30 minutes, centrifugally drying to obtain the composite material of carbon nanotubes and polymethylmethacrylate (PMMA).

Furthermore, the method of preparing the composite material of carbon nanotubes and polystyrene is illustratively introduced herein. The method comprises the following steps.

S501. placing 2 g to 20 g of carbon nanotubes into a flask of 100 ml to 500 ml, adding 50 ml to 250 ml of concentrated nitric acid and 150 ml to 750 ml of concentrated sulfuric acid, and undertaking ultrasonic treatment in a water bath of an ultrasonic wave generator for 2 hours.

S502. cooling the mixture obtained in the aforementioned step to the room temperature, soaking in deionized water for 10 hours, removing the clear liquid of the upper layer, adding deionized water again, and washing with high speed centrifuge until PH of the product becomes 6.

S503. drying the mixture obtained in the aforementioned step in a baking oven for 48 hours to obtain hydroxylated carbon nanotubes.

S504. dispersing the hydroxylated carbon nanotubes into distilled water after ultrasonic treatment, adding into polystyrene lotion to obtain a dispersion solution of carbon nanotubes and polystyrene, and manufacturing the composite material of carbon nanotubes and polystyrene after cooling and drying.

S103. assembling the array substrate and the color filter substrate to form a cell, such that the color filter substrate and the array substrate are bonded together by the conductive sealant.

The grain size of the conductive particle is within a range of 100 nm to 10000 mm. The particular grain size may be determined according to the practical need and is not a limit to the embodiment of the present invention.

What needs to be explained is that the grain size of the conductive particle is related to the distance between the array substrate and the color filter substrate after cell-assembling (i.e., the cell gap). Since the conductive particles manufactured in the present invention have not only the conducting effect but also the effect of supporting the cell gap, the grain size of the conductive particle is preferably greater than the distance between the array substrate and the color filter substrate, and generally 1.2 to 1.5 times greater than the cell gap.

What needs to be further explained is that the conductive sealant may be disposed on the array substrate only such that the color filter substrate is assembled to the array substrate to form a cell; or the conductive sealant may be disposed on the color filter substrate only such that the array substrate is assembled to the color filter substrate to form a cell; or the conductive sealant may be disposed on both the array substrate and the color filter substrate to form a cell after assembling, which is not a limit to the embodiment of the present invention.

An embodiment of the present invention provides a manufacturing method of a display panel comprising, after forming an array substrate and an opposed substrate, disposing a conductive sealant on the array substrate and/or the opposed substrate, the conductive sealant comprising a sealant material and conductive particles, the conductive particles being of a composite material obtained by adding graphene or carbon nanotubes into a resin; and disposing the array substrate and the opposed substrate opposite to each other. Since the conductive particles are of a composite material obtained by adding graphene or carbon nanotubes into a resin in said solution, on one hand, introduction of resin reduces the specific surface area of graphene so as to avoid aggregation of graphene; on the other hand, introduction of resin reduces the Van der Waals force among carbon nanotubes so as to provide good electrical conductibility and supporting effect. Therefore, the problem of bad electrical conduction of the display panel caused by the aggregation of graphene can be solved and the display effect of the display panel can be improved.

The above embodiments of the present invention are given by way of illustration only and thus are not limitative of the protection scope of the present invention, which is determined by the attached claims.

1. A conductive sealant, comprising a sealant material and conductive particles, wherein the conductive particles are of a composite material obtained by adding graphene or carbon nanotubes into a resin.

2. A display panel, comprising a first substrate and a second substrate that are disposed opposite to each other, wherein a conductive sealant according to claim 1 is disposed between the first substrate and the second substrate opposite to each other.

3. The display panel according to claim 2, wherein the composite material obtained by adding graphene or carbon nanotubes into a resin is a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).

4. The display panel according to claim 2, wherein a grain size of the conductive particle is within a range of 100 nm to 10000 nm.

5. The display panel according to claim 2, wherein the grain size of the conductive particle is 1.2 to 1.5 times greater than a cell gap of the display panel, the cell gap of the display panel being a distance between the first substrate and the second substrate.

6. The display panel according to claim 2, wherein the conductive particles are uniformly distributed in the conductive sealant.

7. A manufacturing method of a display panel, comprising:
providing an array substrate;
providing an opposed substrate; and
disposing a conductive sealant on the array substrate and/or the opposed substrate;
wherein the array substrate and the opposed substrate being are disposed opposite to each other; and
wherein the conductive sealant comprises a sealant material and conductive particles, the conductive particles being of a composite material obtained by adding graphene or carbon nanotubes into a resin.

8. The manufacturing method of a display panel according to claim 7, wherein a process of manufacturing the conductive sealant comprises:
adding the conductive particles into the sealant material and stirring, and performing vacuum defoaming so as to manufacture the conductive sealant.

9. The manufacturing method of a display panel according to claim 7, wherein the composite material obtained by adding graphene or carbon nanotubes into a resin is a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).

10. A display device, comprising a display panel according to claim 2.

11. The display panel according to claim 3, wherein a grain size of the conductive particle is within a range of 100 nm to 10000 nm.

12. The display panel according to claim 3, wherein the grain size of the conductive particle is 1.2 to 1.5 times greater than a cell gap of the display panel, the cell gap of the display panel being a distance between the first substrate and the second substrate.

13. The display panel according to claim 3, wherein the conductive particles are uniformly distributed in the conductive sealant.

14. The manufacturing method of a display panel according to claim 8, wherein the composite material obtained by adding graphene or carbon nanotubes into a resin is a composite material of graphene and polystyrene, or a composite material of graphene and polymethylmethacrylate (PMMA), or a composite material of carbon nanotubes and polystyrene, or a composite material of carbon nanotubes and polymethylmethacrylate (PMMA).
